(19) United States
(12) Patent Application Publication
(10) Pub. No.: US 2026/0368294 A1
(43) Pub. Date: Nov. 19, 2026

(54) System and Method for Cognitive-Neural Authorship Verification

(71) Applicant: Alvin Williams, Jr., Philadelphia, PA (US)

(72) Inventor: Alvin Williams, Jr., Philadelphia, PA (US)

(21) Appl. No.: 19/207,223

(22) Filed: May 13, 2025

(51) Int. Cl. G06F 21/32; G06F 3/01

(52) U.S. Cl. CPC G06F 21/32; G06F 3/015

(57) ABSTRACT

A system and method for verifying the authorship of written content using neuro-cognitive and behavioral signals. The invention captures cognitive pauses, revision behaviors, decision latency, and optionally neural inputs to build a unique authorship fingerprint. Applicable in high-assurance domains such as education, law, licensing, and journalism, this invention establishes cognitive authorship as a new layer of digital identity protection.

### CROSS-REFERENCE TO RELATED APPLICATIONS

Not applicable.

### STATEMENT REGARDING FEDERALLY SPONSORED RESEARCH OR DEVELOPMENT

None.

### 0001. FIELD OF THE INVENTION

This invention relates to neurobehavioral identity verification and cognitive authorship analysis. Specifically, it addresses methods for verifying the authenticity of human-authored content through neuro-cognitive indicators such as decision latency, sentence construction variance, micro-pause patterns, and optional neural input capture.

### 0002. BACKGROUND OF THE INVENTION

Traditional authorship scoring systems rely on stylometry or behavioral metrics like typing cadence. However, these approaches may become vulnerable as AI models evolve to mimic these patterns. There is a growing need for a more deeply human layer of verification—anchored in the writer's cognitive fingerprint, including neuro-influenced behavioral signatures and, optionally, biometric brainwave data.

### 0003. SUMMARY OF THE INVENTION

This invention introduces a multi-modal, multi-layered authorship verification system that incorporates neuro-cognitive behavioral signals, including but not limited to hesitation windows, revision pattern mapping, sentence planning signals, and optional biometric indicators. The system may analyze these signals using machine learning to build cognitive profiles that verify authorship authenticity. Each layer contributes independently to the overall confidence score, creating a composite authorship identity. Session-level metadata and drift detection allow for authorship fingerprint tracking across time. Optional EEG or neural interface support may be integrated for high-assurance scenarios.

### 0004. SYSTEM COMPONENTS

Cognitive Signal Layer: Captures micro-pause patterns, sentence latency, and revision rhythm.
Cognitive Identity Engine: Builds neuro-behavioral profiles from writing patterns and input processing.
Confidence Score Display: Shows authorship likelihood based on cognitive traits.
Drift Detection Monitor: Flags major deviations in writing pattern over time.
Session Metadata Recorder: Logs session ID, time, device, and optional biometric data.
Optional Neural Input Interface: Accepts signals from EEG or neural activity sensors.
Consent Protocol and Privacy Layer: Ensures lawful and secure cognitive data use.

### 0005. USE CASE EXAMPLES

Education: Verifying authorship across classroom writing, assignments, assessments, and high-stakes exams.
Licensing: Validating identity in professional certification and credentialing.
Journalism: Protecting authorship of sensitive reports in high-risk environments.
Legal: Authenticating authorship of sworn statements and testimony.
Corporate: Detecting authorship fraud in internal documentation and whistleblower reports.

1. A method for verifying authorship using cognitive-neural input signals derived from behavioral and/or biometric sources.

2. A system comprising a cognitive signal capture layer and a confidence scoring engine that assigns an authorship match score.

3. A cognitive identity engine that constructs neuro-behavioral authorship profiles from real-time or stored writing data.

4. A drift detection monitor configured to track changes in cognitive authorship traits across writing sessions.

5. A session metadata recorder that logs behavioral indicators and optionally neural signal data from a writing session.

6. An optional neural input interface configured to accept brainwave or neural activity signals from EEG or similar devices.

7. A privacy and consent protocol regulating the lawful and ethical use of cognitive-authorship data.

8. Integration with educational, legal, certification, or institutional, business, or corporate systems for identity verification.

9. A method for longitudinal tracking of authorship fingerprints based on changes in cognitive and neural signal patterns.

10. A confidence scoring display that represents authorship likelihood based on a weighted analysis of cognitive traits.

11. A multi-layered cognitive authorship verification system comprising at least two or more independent cognitive input layers, including but not limited to micro-pause analysis, revision rhythm, sentence planning latency, or neural input signals, including but not limited to these, wherein each layer contributes to a composite authorship confidence score indicating authorship integrity.
